(19) United States
(12) Patent Application Publication
(10) Pub. No.: US 2005/0155871 A1
(43) Pub. Date: Jul. 21, 2005

(54) Electrochemical sensor

(76) Inventors: Robert Bruce Grant, Steyning (GB); Frederick L. Tapp, Hillsborough, NC (US)

Correspondence Address: Ira Lee Zebrak;The BOC Group, Inc., Legal Services- Intellectual Property, 575 Mountain Avenue, Murray Hill, NJ, 07974, US

(21) Appl. No.: 10/757,954

(22) Filed: Jan. 15, 2004

(51) Int. Cl. G01N 27/26

(52) U.S. Cl. 205/787; 204/416

(57) ABSTRACT

An organic contaminant molecule sensor comprises an electrochemical cell having a solid state oxygen anion conductor, a measurement electrode formed on a first surface of the conductor for exposure to a monitored environment, and a reference electrode formed on a second surface of the conductor for exposure to a reference environment. The electrodes are formed from, or coated with, material for catalysing the dissociative absorption of oxygen. Means are provided for monitoring the potential difference between the electrodes, whereby, in the absence of organic contaminant molecules in the monitored environment, the potential difference between the electrodes assumes a base value V_{b} and, upon the introduction of organic contaminant molecules into the monitored environment, the potential difference assumes a measurement value Vₘ due to the reaction of the organic contaminant molecules with oxygen in the monitored environment, Vₘ-V_{b} being indicative of the amount of organic contaminant molecules introduced into the monitored environment.

### FIELD OF THE INVENTION

The invention relates to an electrochemical sensor, and more particularly to a sensor for the detection of organic contaminants in low oxygen concentration process environments such as those used in the semiconductor manufacturing industry.

### BACKGROUND OF THE INVENTION

In the semiconductor manufacturing industry, it is important to control the atmosphere (process environment) in which wafers are manufactured. The wafers are desirably manufactured in a controlled environment. Undesirable or varying levels of organic contaminants can result in device and/or equipment failure.

Levels of contaminating organic material in the parts per trillion (ppt) to parts per billion (ppb) range, which corresponds to a partial pressure of 10⁻⁹ to 10⁻⁶ mbar, do not, in general, result in equipment or device failure. However, if the levels of organic contaminants become much higher than this, failures may result. In order to control the process environment, it is necessary to monitor the levels of organic contaminants present. In particular, as some processes are sensitive to contaminant material in the low ppb range, it is therefore desirable to monitor the level of contaminant materials in the ppt range for such processes. However, such monitoring processes are costly and it is difficult to determine an accurate value for the total organic compounds (TOC) present at such low contaminant levels. In addition, many fabrication processes are tolerant of light saturated hydrocarbons such as methane (CH₄) and ethane (C₂H₆), which have a particularly low reaction probabilities with most surfaces and therefore do not take part in the various contamination inducing reactions.

In vacuum based process environments, TOC levels are often determined using mass spectrometry. A mass spectrometer is capable of measuring contaminants present at ppt levels. However the interpretation of such measurements is often complicated by effects such as mass spectral overlap, molecular fragmentation and background effects, for example.

Although mass spectrometers can be used in process environments operating at ambient pressure or above, additional vacuum and sample handling systems are required, which make such instruments very expensive. Under such conditions, it is preferred to use Gas Chromatographic (GC) techniques to monitor the TOC levels present in the process environment. However, in order to monitor contaminants in the ppt range it is necessary to fit the gas chromatogram with a gas concentrator. Gas Chromatography technology can therefore be used to monitor TOC levels in the ppt range in Ultra High Purity (UHP) gas installations in semiconductor fabrication plants.

It should be noted that although Mass Spectrometry and Gas Chromatography are able to detect ppt levels of TOC, their ability to differentiate the presence of the process tolerant light hydrocarbons referred to above from the more harmful organic compounds is limited, which makes it difficult to determine the total levels of damaging hydrocarbons in the process environment.

In addition, because the use of either mass spectrometric or gas chromatographic techniques for determining the TOC levels present in process environments requires specialist equipment, they tend to be rather expensive and are typically only used as Point of Entry (POE) monitors for the whole facility rather than the more useful Point of Use (POU) monitors.

There is therefore a need for a simple, low cost, semi-quantitative sensor, which has a low sensitivity to unreactive organic compounds but can be used at the point of use to qualify the process environment.

### SUMMARY OF THE INVENTION

In a first aspect, the present invention provides an organic contaminant molecule sensor comprising an electrochemical cell having a solid state oxygen anion conductor, a measurement electrode formed on a first surface of the conductor for exposure to a monitored environment, and a reference electrode formed on a second surface of the conductor for exposure to a reference environment, the electrodes comprising material for catalysing the dissociative absorption of oxygen; and means for monitoring the potential difference between the electrodes, whereby, in the absence of organic contaminant molecules in the monitored environment, the potential difference between the electrodes assumes a base value V_{b} and, upon the introduction of organic contaminant molecules into the monitored environment, the potential difference assumes a measurement value Vₘ due to the reaction of the organic contaminant molecules with oxygen in the monitored environment, (Vₘ-V_{b}) being indicative of the amount of organic contaminant molecules introduced into the monitored environment.

In a second aspect, the present invention provides a method of monitoring the amount of organic contaminant introduced into a monitored environment, the method comprising the steps of providing an electrochemical cell having a solid state oxygen anion conductor, a measurement electrode formed on a first surface of the conductor for exposure to the monitored environment, and a reference electrode formed on a second surface of the conductor for exposure to a reference environment, the electrodes comprising material for catalysing the dissociative absorption of oxygen; and monitoring the potential difference between the electrodes, whereby, in the absence of organic contaminant molecules in the monitored environment, the potential difference between the electrodes assumes a base value V_{b} and, upon the introduction of organic contaminant molecules into the monitored environment, the potential difference assumes a measurement value Vₘ due to the reaction of the organic contaminant molecules with oxygen in the monitored environment, Vₘ-V_{b} being indicative of the amount of organic contaminant molecules introduced into the monitored environment.

### BRIEF DESCRIPTION OF THE DRAWINGS

The present invention will now be described, by way of example only, with reference to the accompanying drawings, in which:

FIG. 1 is a schematic cross-section through a first embodiment of an electrochemical sensor;

FIG. 2 is a schematic cross-section through a second embodiment of an electrochemical sensor;

FIG. 3 is a schematic cross-section through a third embodiment of an electrochemical sensor;

FIG. 4 is a graph depicting the variation of the potential difference across the electrodes of the sensor with the partial pressure of hydrocarbon added to the monitored environment; and

FIG. 5 is a graph depicting the variation of sensor output voltage with oxygen partial pressure in the monitored environment with atmospheric air in the reference environment.

### DETAILED DESCRIPTION OF THE INVENTION

Solid state oxygen anion conductors (solid state electrolytes) are generally formed from doped metal oxides such as gadolinium doped ceria or yttria stabilised zirconia (YSZ). At temperatures below the critical temperature for each electrolyte (T_{c}) the electrolyte material is non-conducting. At temperatures above T_{c} the electrolyte becomes progressively more conductive.

The level of oxygen in any monitored environment is determined by the electrochemical potentials generated by the reduction of oxygen gas at both the measurement and reference electrodes. The steps associated with the overall reduction reactions at each electrode are set out below, the half-cell reaction at each electrode being defined by equations 1 and 2 below.

$$\begin{matrix}{O}_{2 ( gas )} ⇄ 2 {O}_{( ads )} & ( Equation 1 ) \\ {O}_{( ads )} + 2 e ⇄ {O}^{2 -} & ( Equation 2 )\end{matrix}$$

The electrochemical potential generated at each electrode is determined by the Nernst equation:

$$E = {E}^{Θ} + \frac{RT}{2 F} ln \frac{a ( {O}_{ads} )}{a ( {O}^{2 -} )} \qquad ( Equation 3 )$$

where
E is the electrochemical half-cell potential at the reference or measurement electrode respectively;
E^{Θ} is the standard electrochemical half cell potential of the cell at unit O(_{ads}) activity
R is the gas constant
T is the temperature of the cell
F is Faraday's constant
a(O_{ads}) and a(O²⁻) are the activities of the adsorbed oxygen at the electrode surface and reduced oxygen anion in the solid state ionic conductor respectively.

The activity of adsorbed oxygen at the electrode surface is directly proportional to the partial pressure of oxygen gas in the environment adjacent the electrode as defined by equation 4 below:
a_{Oads}=K P_{O2}^{1/2} (Equation 4)

Since a(O²⁻) is unity, by definition, and the activity of the adsorbed oxygen at the electrode surface is proportional to the partial pressure of the oxygen in the environment adjacent the electrode surface (Equation 4), the half cell potential can be written in terms of the partial pressure of oxygen in the particular environment adjacent the measurement or reference electrode respectively

$$E = {E}^{Θ} + \frac{RT}{4 F} ln {P}_{O2} \qquad ( Equation 5 )$$

The potential difference V generated across the cell is defined in terms of the difference in the half-cell potentials between the reference and measurement electrodes in accordance with Equation 6.

$$V = {E}_{( R )} - {E}_{( M )} = \frac{RT}{4 F} Ln ( \frac{{P}_{O2 ( R )}}{{P}_{O2 ( M )}} ) \qquad ( Equation 6 )$$

where
V is the potential difference across the cell
E_{(R)} and E_{(M)} are the electrochemical potentials at the reference and measurement electrodes respectively;
R, T and F are as defined above; and
P_{O2(R)} and P_{O2(M)} are the partial pressures of oxygen at the reference and measurement electrodes respectively.

In process environments such as the oxygen deficient environments encountered in the manufacture of semiconductor products, the partial pressure of oxygen adjacent the measurement electrode is considerably less than that adjacent the reference electrode. Since the electrochemical potential at each electrode is governed by the Nernst equation, as the partial pressure of oxygen at the measurement electrode decreases, the electrochemical potential at the measurement electrode changes, which results in the formation of a potential difference across the cell at temperatures above the critical temperature. The potential difference across the cell is determined by the ratio of the partial pressure of oxygen at the reference and measurement electrodes in accordance with Equation 6 above.

In the absence of organic contaminants, the oxygen partial pressures at the reference and measurement electrodes are stable and so the potential difference between the electrodes is constant. However, when organic contaminants are introduced into the monitored environment, they react with oxygen adsorbed on the measurement electrode and reduce the oxygen surface concentration in accordance with Equation 7:

$${C}_{x} {H}_{y} + ( 2 x + \frac{y}{2} ) {O}_{( ads )} -> {xCO}_{2} + \frac{y}{2} {H}_{2} O \qquad ( Equation 7 )$$

This reaction produces a change in the equilibrium oxygen surface concentration at the measurement electrode, and therefore produces a change in the observed cell voltage. By suitable calibration, the difference Vₘ-V_{b} between the potential differences in the presence and absence of organic contaminant molecules can be used to provide a direct indication of the partial pressure of hydrocarbon introduced into the monitored environment.

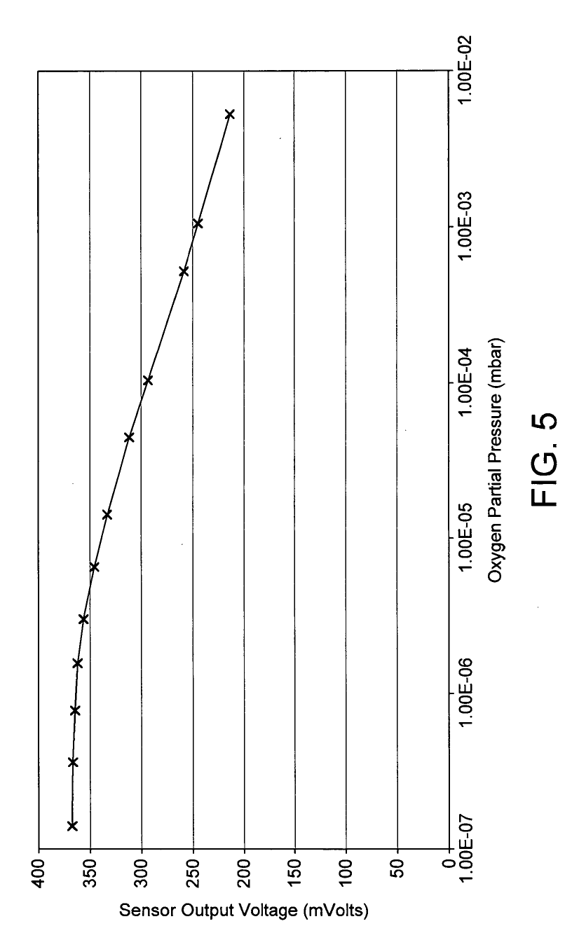

Typically atmospheric air is used as the reference gas and a typical cell response is shown in FIG. 5. Note that at measurement partial pressures above 10⁻⁶ mbar the cell voltage follows Equation 6 above but at measurement partial pressures below 10⁻⁷ mbar the cell voltage no longer responds to changes in measurement oxygen partial pressure. This non-Nernstian behaviour is due, in part, to electrochemical semipermeability where oxygen anions are continuously transported across the cell and act as a source of oxygen to the measurement environment, thereby swamping the effect of genuine gas phase oxygen and causing the sensor to become unresponsive.

From Equation 7, it can be seen that the surface concentration of oxygen affects the amount of hydrocarbon consumed in the reaction. It follows then that controlling the sensor oxygen surface concentration can impact the detection limit of the sensor. The measurement electrode oxygen surface concentration will be the summation of the effects of the oxygen electrochemical semi-permeability current and the gas phase oxygen partial pressure. Thus, in oxygen deficient atmospheres, the sensor preferably comprises means for controlling the oxygen electrochemical semi-permeability of the cell so as to control the sensitivity of the sensor to the introduction of the organic contaminant molecules.

The oxygen electrochemical semi-permeability can be controlled by, for example, providing an additional, working, electrode in the reference environment and means for controlling the electrical current flowing between the working and measurement electrodes, and/or by providing means for controlling the concentration of oxygen within the reference environment. This can control the rate of flux of oxygen anions flowing between the electrodes to allow the sensor to determine low levels of organic contaminant in low oxygen concentration environments.

The sensor is easy to use and can be used at the point of use rather than the point of entry to provide accurate information about the process environment. The sensor is easily and readily manufactured using techniques known to a person skilled in the art. The electrodes can be applied to a tube of an oxygen anion conductor solid state electrolyte such as ytttria stabilised zirconia either in the form of an ink or a paint or using techniques such as sputtering. The sensor can be suitably supplied with heater means to control the temperature of the electrolyte.

The reference electrode is suitably formed from a material able to catalyse the dissociation of oxygen, for example, platinum. The reference environment can be derived from a gaseous or solid state source of oxygen. Typically atmospheric air is used as a gaseous reference source of oxygen although other gas compositions can be used. Solid state sources of oxygen typically comprise a metal/metal oxide couple such as Cu/Cu₂O and Pd/PdO or a metal oxide/metal oxide couple such as Cu₂O/CuO. The particular solid state reference materials chosen will depend on the operating environment of the sensor.

The solid state electrolyte comprising an oxygen anion conductor is suitably formed from a material exhibiting oxygen anion conduction at temperatures above 300° C. Suitable oxygen anion conductors include gadolinium doped ceria and yttria stabilised zirconia. Preferred materials for use as the solid state oxygen anion conductor include 3% and 8% molar yttria stabilised zirconia (YSZ), both of which are commercially available.

A radiative heater is preferably used to control the temperature of the cell. A thermocouple is preferably used to monitor the temperature of the cell.

The range of the sensor may be extended to include environments with oxygen in the ambient by using the sensor in an extractive mode and adding an oxygen trap.

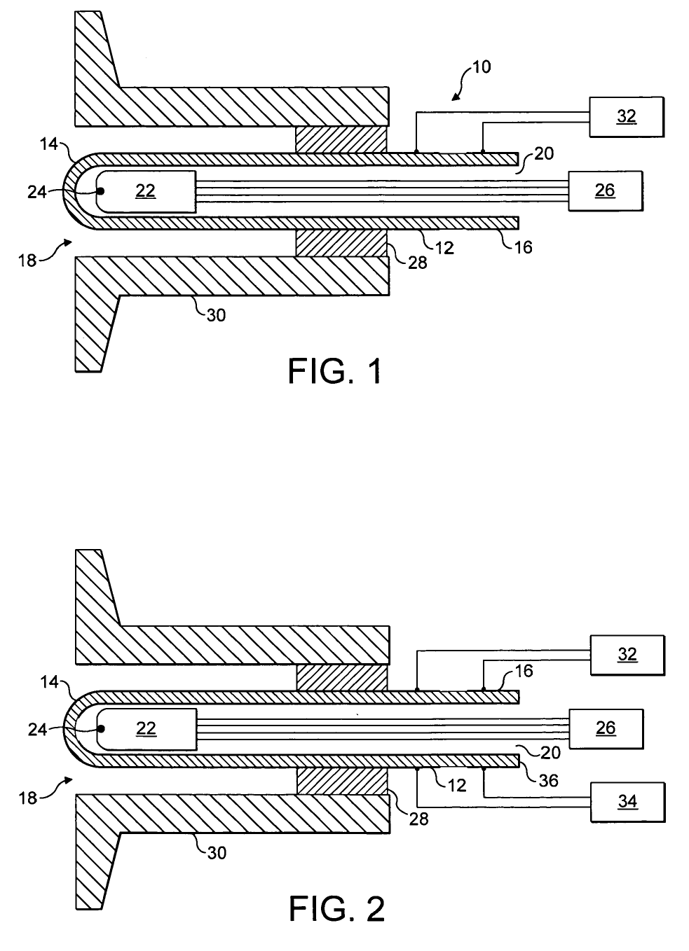

The electrochemical sensor 10 of FIG. 1 comprises a solid state electrolyte 12 in the form of 8% yttria stabilised zirconia oxygen anion conducting tube coated on the inner and outer surfaces thereof with a porous catalyst film. The inner and outer films are electrically isolated so as to form a measurement electrode 14 and a reference electrode 16. The electrodes 14, 16 may be formed from platinum deposited on the electrolyte 12 using techniques such as vacuum sputtering or applying a suitable commercially available “ink” to the surface, for example. In the event that the electrode is formed on the surface of the sensor using ink, the whole assembly must be fired in a suitable atmosphere determined by the nature of the ink.

The measurement electrode 14 is placed in contact with a monitored environment 18, and the reference electrode 16 is placed in contact with a reference environment 20. The reference environment 20 may be either a gaseous source of oxygen at constant pressure (such as atmospheric air) or a solid-state source of oxygen, typically a metal/metal oxide couple such as Cu/Cu₂O and Pd/PdO or a metal oxide/metal oxide couple such as Cu₂O/CuO. The sensor is mounted in the environment to be monitored using a stainless steel vacuum flange 30, via a ceramic to metal seal 28, which isolates the monitored environment from the reference environment.

The solid state electrolyte 12 is heated internally by a heater 22. The sensor temperature is measured using a suitable measuring device, such as a thermocouple arrangement 24. The temperature of the sensor is controlled by a suitable control device 26. A voltage measurement device 32 is provided to measure the potential difference across the cell.

In use, the measurement electrode is exposed to an environment to be monitored, such as a chamber under vacuum, and the sensor is heated using the heater 22 to a temperature in excess of 650° C. Under open circuit conditions the difference in oxygen partial pressures between the reference and the monitored environments results in a potential difference between the electrodes 14, 16. In the absence of organic contaminants, the oxygen partial pressures at the reference and measurement electrodes are stable, and so an equilibrium cell voltage V_{b} is established and measured. When hydrocarbons are added to the measurement chamber, a reaction occurs in accordance with Equation 7, which changes the equilibrium oxygen surface concentration at the measurement electrode.

$${C}_{x} {H}_{y} + ( 2 x + \frac{y}{2} ) {O}_{( ads )} -> {xCO}_{2} + \frac{y}{2} {H}_{2} O \qquad ( Equation 7 )$$

This reaction produces a change in the observed cell voltage Vₘ. As indicated in FIG. 4, the voltage deviation (Vₘ-V_{b}) provides a direct indication of the partial pressure of hydrocarbon added to the measurement chamber.

As can be seen from Equation 7, the surface concentration of oxygen affects the amount of hydrocarbon consumed in the reaction. It follows then that controlling the sensor oxygen surface concentration can affect the detection limit of the sensor.

The measurement electrode oxygen surface concentration will be the summation of the effects of the oxygen electrochemical semi-permeability current and the gas phase oxygen partial pressure. The oxygen electrochemical semi-permeability can be controlled by different means:
1) Control of oxygen concentration in the reference environment
2) Application of reverse current bias

A schematic of a second embodiment of a sensor operated to control oxygen electrochemical semi-permeability is shown in FIG. 2. The schematic shows a similar sensor to FIG. 1, with the addition of a controlled current device 34 attached to the measurement electrode 14 and an additional, working electrode 36 within the reference environment. Oxygen electrochemical semi-permeability is controlled by the addition of variable current levels, which are used to optimize the sensor's sensitivity to hydrocarbon addition. Thus, the control of the electrochemical semi-permeability for oxygen leads to an improved lower detection limits for the sensor.

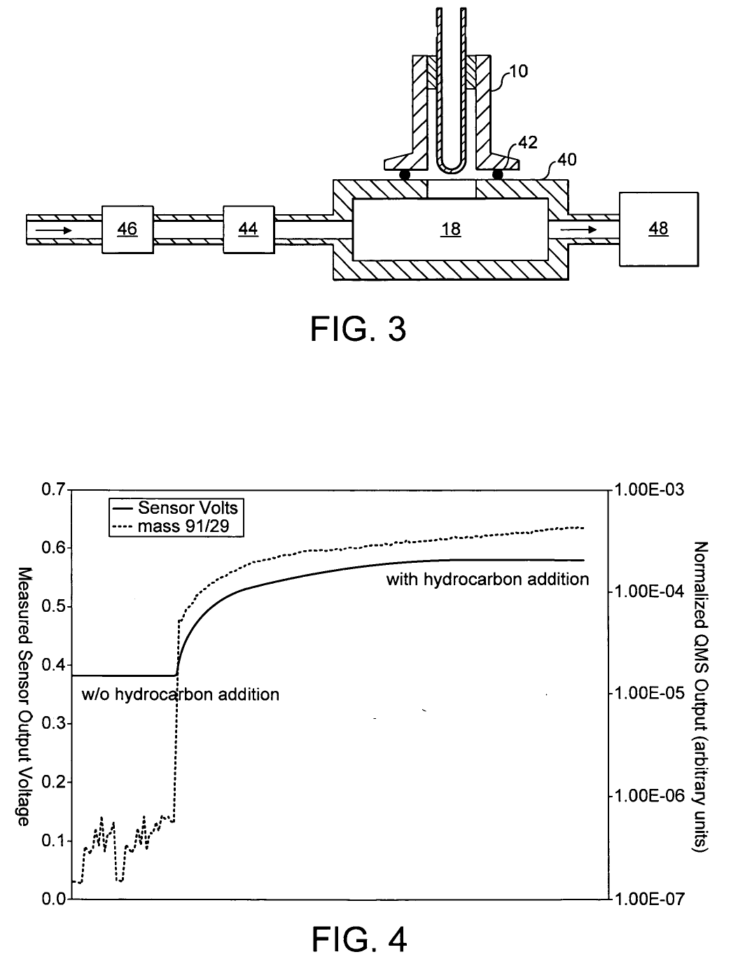

The discussion so far has considered the use of the sensor to monitor hydrocarbons in an oxygen depleted environment, such as a vacuum chamber for a semiconductor manufacturing process. The range of the sensor application can be extended to include environments with oxygen in the ambient by using the sensor in an extractive mode and adding an oxygen trap. A block diagram of such a set-up is shown in FIG. 3. The sensor 10 is mounted to a sample block 40 using a suitable seal 42. The gas sample for monitoring is extracted through the sample block 40 by a sampling pump 48. A suitable flow control device 44 limits the sample flow and controls the pressure in the sample block 40. Oxygen is removed from the extracted sample by a suitable oxygen trap 46 purifier, getter or solid state oxygen pump. Operation of the sensor in this mode eliminates oxygen cross-sensitivity errors. Also in this configuration the sensor 10 can be used to sample gas streams at pressures up to 1 atmosphere.

In summary, an organic contaminant molecule sensor comprises an electrochemical cell having a solid state oxygen anion conductor, a measurement electrode formed on a first surface of the conductor for exposure to a monitored environment, and a reference electrode formed on a second surface of the conductor for exposure to a reference environment. The electrodes are formed from, or coated with, material for catalysing the dissociative absorption of oxygen. Means are provided for monitoring the potential difference between the electrodes, whereby, in the absence of organic contaminant molecules in the monitored environment, the potential difference between the electrodes assumes a base value V_{b} and, upon the introduction of organic contaminant molecules into the monitored environment, the potential difference assumes a measurement value Vₘ due to the reaction of the organic contaminant molecules with oxygen in the monitored environment, Vₘ-V_{b} being indicative of the amount of organic contaminant molecules introduced into the monitored environment.

While the foregoing description and drawings represent the preferred embodiments of the present invention, it will be apparent to those skilled in the art that various changes and modifications may be made therein without departing from the true spirit and scope of the present invention.

1. An organic contaminant molecule sensor comprising: an electrochemical cell having a solid state oxygen anion conductor, a measurement electrode formed on a first surface of the conductor for exposure to a monitored environment, and a reference electrode formed on a second surface of the conductor for exposure to a reference environment, the electrodes comprising material for catalysing the dissociative absorption of oxygen; and means for monitoring the potential difference between the electrodes, so that, in the absence of organic contaminant molecules in the monitored environment, the potential difference between the electrodes assumes a base value V_{b} and, upon the introduction of organic contaminant molecules into the monitored environment, the potential difference assumes a measurement value Vₘ due to the reaction of the organic contaminant molecules with oxygen in the monitored environment, Vₘ-V_{b} being indicative of the amount of organic contaminant molecules introduced into the monitored environment.

2. A sensor according to claim 1 comprising means for controlling the temperature of the cell.

3. A sensor according to claim 2 wherein the control means comprises a heater and a thermocouple arrangement.

4. A sensor according to claim 1 wherein the material for catalysing the dissociative absorption of oxygen is platinum.

5. A sensor according to claim 1 wherein the solid state oxygen anion conductor is selected from the group of materials comprising gadolinium doped ceria and yttria stabilised zirconia.

6. A sensor according to claim 1 wherein the reference oxygen environment is a solid-state source of oxygen typically from a metal/metal oxide couple such as Cu/Cu₂O and Pd/PdO or a metal oxide/metal oxide couple such as Cu₂O/CuO.

7. A sensor according to claim 1 comprising means for controlling the oxygen electrochemical semi-permeability of the cell so as to control the sensitivity of the sensor to the introduction of the organic contaminant molecules.

8. A sensor according to claim 7 wherein the oxygen electrochemical semi-permeability control means comprises an additional electrode in the reference environment and means for controlling the rate of flux of oxygen anions flowing between the additional electrode and the measurement electrode.

9. A sensor according to claim 8 wherein the oxygen electrochemical semi-permeability control means comprises means for controlling the electrical current flowing between the additional electrode and the measurement electrode.

10. A sensor according to claim 7 wherein the oxygen electrochemical semi-permeability control means comprises means for controlling the concentration of oxygen within the reference environment.

11. A sensor according to claim 1 further comprising means for controlling the amount of oxygen within the monitored environment.

12. A sensor according to claim 11 further comprising means for controlling the pressure within the monitored environment.

13. A sensor according to claim 11 further comprising means for drawing a flow of gas into the monitored environment, and means for extracting oxygen from gas being drawn into the monitored environment.

14. A method of monitoring the amount of organic contaminant introduced into a monitored environment comprising: (a) providing an electrochemical cell having a solid state oxygen anion conductor, a measurement electrode formed on a first surface of the conductor for exposure to the monitored environment, and a reference electrode formed on a second surface of the conductor for exposure to a reference environment, the electrodes comprising material for catalysing the dissociative absorption of oxygen; and (b)(1) monitoring the potential difference between the electrodes in the absence of organic contaminant molecules in the monitored environment, and (b)(2) monitoring the potential difference between the electrodes upon the introduction of organic contaminant molecules into the monitored environment where the potential difference in the presence of the organic contaminant molecules is a function of the reaction of the organic contaminant molecules is the oxygen in the monitored environment; so that the difference between (I) the potential difference between the electrodes upon the introduction of organic contaminant molecules and (II) the potential difference between the electrodes in the absence of organic contaminant molecules is a function of the amount of organic contaminant molecules introduced into the monitored environment.

15. A method according to claim 14 further comprising the step of controlling the temperature of the cell.

16. A method according to claim 14 further comprising the step of controlling the oxygen electrochemical semi-permeability of the cell so as to control the sensitivity of the sensor to the introduction of the organic contaminant molecules.

17. A method according to claim 16 wherein the oxygen electrochemical semi-permeability of the cell is controlled by controlling the rate of flux of oxygen anions flowing between the measurement electrode and an additional electrode in the reference environment.

18. A method according to claim 17 wherein the rate of flux of oxygen anions flowing between the electrodes is controlled by controlling the electrical current flowing between the measurement electrode and the additional electrode.

19. A method according to claim 17 wherein the rate of flux of oxygen anions flowing between the electrodes is controlled by controlling the concentration of oxygen within the reference environment.

20. A method according to claim 14 further comprising the step of controlling the amount of oxygen within the monitored environment.
